(19) United States
(12) Patent Application Publication
(10) Pub. No.: US 2026/0042208 A1
(43) Pub. Date: Feb. 12, 2026

(54) CONTROL METHOD FOR ROBOT SYSTEM, METHOD OF DESIGNING MOTION PROFILE, AND PROGRAM STORED IN RECORDING MEDIUM FOR DESIGNING MOTION PROFILE

(71) Applicant: SEMES CO., LTD., Cheonan-si (KR)

(72) Inventors: Hee Jae BYUN, Yongin-si (KR); Kyo Bong KIM, Seongnam-si (KR); Jae Won CHOI, Osan-si (KR); Sang Oh KIM, Seoul (KR)

(73) Assignee: SEMES CO., LTD., Cheonan-si (KR)

(21) Appl. No.: 19/290,481

(22) Filed: Aug. 5, 2025

(30) Foreign Application Priority Data
Aug. 6, 2024 (KR) 10-2024-0104811

(51) Int. Cl. B25J 9/16; B25J 19/02

(52) U.S. Cl. CPC B25J 9/1664; B25J 9/1653; B25J 19/02

(57) ABSTRACT

Disclosed is a method of controlling a robot system, the method including: a vibration information collection operation of observing vibration generated during an operation of a robot and collecting natural frequency of the vibration; a motion profile design operation of designing a motion profile based on the natural frequency collected in the vibration information collection operation; and a robot operating operation of operating the robot based on the motion profile designed in the motion profile design operation, in which the motion profile design operation includes designing a first order motion profile based on a primary vibration coefficient, which is a multiple of a reciprocal number of the natural frequency.

### CROSS-REFERENCE TO RELATED APPLICATION

This application claims priority to and the benefit of Korean Patent Application No. 10-2024-0104811 filed in the Korean Intellectual Property Office on Aug. 6, 2024, the entire contents of which are incorporated herein by reference.

### TECHNICAL FIELD

The present invention relates to a control method for a robot system, a method of designing a motion profile, and a program stored in a recording medium for designing a motion profile, and more specifically, a technology to precisely control a motion of a robot and generate an optimized motion profile to improve the robot's performance.

### BACKGROUND ART

In the modern industrial field, robots play an important role in automating various tasks and maximizing efficiency. In particular, accurate motion control of robots is essential in high-precision tasks, such as semiconductor manufacturing processes. Semiconductor manufacturing equipment is used to manufacture semiconductor devices, and various types of robots are provided in this equipment. For example, various types of robots, such as a transfer device that transfers a substrate such as a wafer, a chuck device that supports and rotates a substrate, and a storage device that stores the substrate, are provided to semiconductor manufacturing equipment.

These robots operate based on motion profiles. The motion profile includes data on a movement path, velocity, acceleration, and the like. In general, a trapezoidal motion profile is used to set the motion of a robot. The trapezoidal velocity motion profile may be a velocity motion profile having an acceleration section, a constant velocity section, and a deceleration section.

Meanwhile, the substrate mounted on the robot is greatly affected by the vibration of the robot. When vibration occurs, the substrate may be damaged or contaminated by pollutants, such as particles, generated by the vibration of the robot. In the case of a robot that transfers a substrate, the position of the substrate mounted on the hand may be distorted. The vibration of the robot may be generated by the operation of the robot.

Currently, when designing a motion profile, the user generates a motion profile without any special criteria. That is, in many cases, the user generates a motion profile based on simple experience of the acceleration, the constant velocity, the deceleration section, the length of the deceleration section, the length of the constant velocity section, and the like. Therefore, a lot of trial and errors occur, and it takes a lot of time to generate the motion profile. In addition, the vibration of the robot as described above is affected by the motion profile. Therefore, the vibration of the robot may be enhanced or attenuated depending on how the user designs the motion profile.

### SUMMARY OF THE INVENTION

The present invention has been made in an effort to provide a control method for a robot system, a method of designing a motion profile, and a program stored in a recording medium for designing a motion profile, which design a motion profile that may effectively reduce vibration occurring when a robot operates.

The present invention has also been made in an effort to provide a control method for a robot system, a method of designing a motion profile, and a program stored in a recording medium for designing a motion profile, which significantly reduce the time required to design a motion profile.

The present invention has also been made in an effort to provide a control method for a robot system, a method of designing a motion profile, and a program stored in a recording medium for designing a motion profile, which control an operation of a robot more precisely and stably by designing a motion profile by reflecting natural frequency of the robot.

The objectives of the present disclosure are not limited thereto and other objectives not stated herein may be clearly understood by those skilled in the art from the following description.

An exemplary embodiment of the present invention, a method of controlling a robot system, the method comprising: a vibration information collection operation of observing vibration generated during an operation of a robot and collecting natural frequency of the vibration; a motion profile design operation of designing a motion profile based on the natural frequency collected in the vibration information collection operation; and a robot operating operation of operating the robot based on the motion profile designed in the motion profile design operation, wherein the motion profile design operation includes may designing a first order motion profile based on a primary vibration coefficient, which is a multiple of a reciprocal number of the natural frequency.

According to the exemplary embodiment of the present invention, the primary vibration coefficient is defined by Equation 1 below,

$$α = \frac{i}{{f}_{n}} , ( i = 1 , 2 , 3 , … ) \qquad ( Equation 1 )$$

α: the primary vibration coefficient
i: natural number of 1 or more
fₙ: the natural frequency
   the motion profile design operation includes: temporarily designing the primary vibration coefficient while sequentially increasing a value of i from 1; and checking whether a length of a constant velocity section may include in the first order motion profile based on the temporarily designed primary vibration coefficient is equal to or greater than 0.

According to the exemplary embodiment of the present invention, the method may further include when the length of the constant velocity section is equal to or greater than 0, temporarily designing the primary vibration coefficient again by increasing the value of i; and when the length of the constant velocity section is less than 0, determining a value obtained by reducing the value of i by 1 as a final value of i and deriving a final primary vibration coefficient based on the determined value of i.

According to the exemplary embodiment of the present invention, the method may further include when the determined value of i is 1, determining the first order motion profile based on the final primary vibration coefficient as the motion profile operating the robot.

According to the exemplary embodiment of the present invention, the method may further include when the determined value of i is not 1, designing a second order motion profile based on a secondary vibration coefficient, wherein the secondary vibration coefficient is defined by Equation 2 below,

$$β = 2 \frac{1}{α} \frac{j}{{f}_{n}} , ( j = 1 , 2 , 3 , … ) \qquad ( Equation 2 )$$

β: the secondary vibration coefficient
α: the primary vibration coefficient
j: natural number of 1 or more
fₙ: the natural frequency.

According to the exemplary embodiment of the present invention, wherein the motion profile design operation may include: temporarily designing the secondary vibration coefficient while sequentially increasing a value of j from 1; and determining whether the temporarily designed secondary vibration coefficient is greater than 0 and equal to or less than 1.

According to the exemplary embodiment of the present invention, the method may further include when the temporarily designed secondary vibration coefficient satisfies a condition greater than 0 and equal to or less than 1, temporarily designing the secondary vibration coefficient again by increasing the value of j; and when the temporarily designed secondary vibration coefficient does not satisfy the condition greater than 0 and equal to or less than 1, determining a value obtained by reducing the value of j by 1 as a final value of j, and deriving the final secondary vibration coefficient based on the determined final value of j.

According to the exemplary embodiment of the present invention, the method may further include when the determined value of j is 1, determining the second order motion profile based on the final secondary vibration coefficient as the motion profile operating the robot.

According to the exemplary embodiment of the present invention, the method may further include when the determined value of j is not 1, designing a third order motion profile based on a tertiary vibration coefficient, wherein the tertiary vibration coefficient is defined by Equation 3 below,

$$γ = 4 \frac{1}{α β} \frac{k}{{f}_{n}} , ( k = 1 , 2 , 3 , … ) \qquad ( Equation 3 )$$

β: the tertiary vibration coefficient
α: the primary vibration coefficient
β: the secondary vibration coefficient
k: natural number of 1 or more
fₙ: the natural frequency.

According to the exemplary embodiment of the present invention, wherein the motion profile design operation may include: temporarily designing the tertiary vibration coefficient while sequentially increasing the value of k from 1; and determining whether the temporarily designed tertiary vibration coefficient is greater than 0 and equal to or less than 1.

According to the exemplary embodiment of the present invention, the method may further include when the temporarily designed tertiary vibration coefficient satisfies a condition greater than 0 and equal to or less than 1, temporarily designing the tertiary vibration coefficient again by increasing the value of k; and when the temporarily designed tertiary vibration coefficient does not satisfy the condition greater than 0 and equal to or less than 1, determining a value obtained by reducing the value of k by 1 as a final value of k, and deriving the final tertiary vibration coefficient based on the determined final value of k.

According to the exemplary embodiment of the present invention, the method may further include when the temporarily designed tertiary vibration coefficient satisfies a condition greater than 0 and equal to or less than 1, temporarily designing the tertiary vibration coefficient again by increasing the value of k; and when the temporarily designed tertiary vibration coefficient does not satisfy the condition greater than 0 and equal to or less than 1, determining the value obtained by reducing the value of k by 1 as a final value of k, and deriving the final tertiary vibration coefficient based on the determined final value of k.

According to the exemplary embodiment of the present invention, the method may further include determining the third order motion profile based on the final tertiary vibration coefficient as the motion profile operating the robot.

According to the exemplary embodiment of the present invention, wherein the motion profile design operation includes designing the first order motion profile based on a design parameter which is a limit condition for designing the motion profile and a multiple of a natural vibration period, and the design parameter includes: an operating time an actuator of the robot is driven in the robot operating operation; and a movement distance, which is a distance that an object moves by the driving of the actuator of the robot while the robot is operating, and the motion profile may be designed to satisfy the operating time of the actuator and the movement distance of the object.

According to the exemplary embodiment of the present invention, wherein the design parameter further includes a limit velocity and a limit acceleration of the actuator, and the motion profile may be designed so that a maximum velocity and a maximum acceleration of the actuator do not exceed the limit velocity and the limit acceleration.

An exemplary embodiment of the present invention, a method of designing a velocity motion profile for operating a robot applied to semiconductor manufacturing equipment, the method comprising: deriving a natural frequency by observing vibration generated while the robot is operating, and determining an application time of a counter jerk while changing a time interval from a time point when a main jerk occurs to a time point when the counter jerk occurs by the velocity motion profile based on the derived natural frequency, wherein a first order velocity motion profile may be designed based on an application time point when the determined counter jerk is applied.

According to the exemplary embodiment of the present invention, wherein the time point of the application of the counter jerk maybe determined while changing the time interval to a multiple of a natural vibration period, which is a reciprocal number of the natural frequency.

According to the exemplary embodiment of the present invention, wherein the velocity motion profile is generated based on a design parameter, which is a preset limit condition, and the design parameter may include an operating time of the robot, a movement distance of an object moved by the operation of the robot, a limit velocity of a motor of the robot, and a limit acceleration of the motor.

According to the exemplary embodiment of the present invention, wherein at least one nth order velocity profile that satisfies the design parameter, which is a limit condition, is generated while increasing the order of the main jerk and the counter jerk generated from the first order velocity profile n times, and any one of the first order velocity profile and the nth order velocity profile may be determined as the velocity profile for operating the robot.

An exemplary embodiment of the present invention, a program stored in a recording medium performing the method of designing the velocity profile of claim 16.

According to the exemplary embodiment of the present invention, vibration that may occur when a robot operates may be effectively reduced.

In addition, according to the exemplary embodiment of the present invention, it is possible to significantly shorten the time required to design a motion profile.

In addition, according to the exemplary embodiment of the present invention, by designing a motion profile by reflecting the natural frequency of the robot, the robot's operation may be controlled more precisely and stably.

Effects of the present disclosure are not limited to those described above and effects not stated above will be clearly understood to those skilled in the art from the specification and the accompanying drawings.

### BRIEF DESCRIPTION OF THE DRAWINGS

FIG. 1 is a block diagram illustrating a configuration of a robot system of the present invention.

FIG. 2 is a diagram for describing a robot of FIG. 1 and a sensor installed in the robot.

FIG. 3 is a diagram for describing an example of an operation of the robot of FIG. 1.

FIG. 4 is a block diagram for describing a method of controlling an operation of the robot by observing a vibration of a substrate of FIG. 1.

FIG. 5 is a flowchart illustrating a control method for a robot system according to an exemplary embodiment of the present invention.

FIG. 6 is a graph for describing a method of reducing vibration of a robot by using an input molding machine of FIG. 4.

FIG. 7 is a graph for describing a main cause of generating vibration in a robot.

FIG. 8 is a graph illustration a comparison of residual vibration response forms according to a time point of application of a counter jerk for a main jerk.

FIG. 9 is a flowchart illustrating a method of designing a motion profile according to an exemplary embodiment of the present invention.

FIG. 10 is graphs illustrating a method of designing a first order motion profile of FIG. 9.

FIG. 11 is a graph illustrating changes in the position and velocity of the hand of the robot according to the sizes of the main jerk and the counter jerk and the timing of applying the counter jerk in relation to the design of the first order motion profile.

FIG. 12 is graphs illustrating a method of designing a second order motion profile of FIG. 9.

FIG. 13 is graphs illustrating a method of designing a third order motion profile of FIG. 9.

FIG. 14 is a diagram illustrating an example of first order to third order velocity motion profiles generated by the method of designing the motion profile of the present invention.

FIG. 15 is graphs illustrating charts related to a jerk in the first order, second order, and third order motion profiles.

### DETAILED DESCRIPTION

Hereinafter, an exemplary embodiment of the present invention will be described more fully hereinafter with reference to the accompanying drawings, in which exemplary embodiments of the invention are illustrated. However, the present invention may be variously implemented and is not limited to the following exemplary embodiments. In the following description of the present invention, a detailed description of known functions and configurations incorporated herein is omitted to avoid making the subject matter of the present invention unclear. In addition, the same reference numerals are used throughout the drawings for parts having similar functions and actions.

Unless explicitly described to the contrary, the word “include” will be understood to imply the inclusion of stated elements but not the exclusion of any other elements. It will be appreciated that terms “including” and “having” are intended to designate the existence of characteristics, numbers, operations, operations, constituent elements, and components described in the specification or a combination thereof, and do not exclude a possibility of the existence or addition of one or more other characteristics, numbers, operations, operations, constituent elements, and components, or a combination thereof in advance.

Singular expressions used herein include plurals expressions unless they have definitely opposite meanings in the context. Accordingly, shapes, sizes, and the like of the elements in the drawing may be exaggerated for clearer description.

Terms, such as first and second, are used for describing various constituent elements, but the constituent elements are not limited by the terms. The terms are used only to discriminate one constituent element from another constituent element. For example, without departing from the scope of the invention, a first constituent element may be named as a second constituent element, and similarly a second constituent element may be named as a first constituent element.

It should be understood that when one constituent element referred to as being “coupled to” or “connected to” another constituent element, one constituent element may be directly coupled to or connected to the other constituent element, but intervening the other constituent elements may also be present. In contrast, when one constituent element is “directly coupled to or “directly connected to” another constituent element, it should be understood that there are no intervening element present. Other expressions describing the relationship between the constituent elements, such as “between ˜ and ˜”, “just between ˜ and ˜”, or “adjacent to ˜” and “directly adjacent to ˜” should be interpreted similarly.

All terms used herein including technical or scientific terms have the same meanings as meanings which are generally understood by those skilled in the art unless they are differently defined. Terms defined in generally used dictionary shall be construed that they have meanings matching those in the context of a related art, and shall not be construed in ideal or excessively formal meanings unless they are clearly defined in the present application.

Hereinafter, a robot system of the present invention will be described. The robot system described below may be provided in semiconductor manufacturing equipment or display manufacturing equipment capable of manufacturing a semiconductor device or a display. Furthermore, the robot 30 described below may be modified in various forms, such as a transfer device having a hand holding a substrate such as a wafer, a process device for processing a substrate, a storage device for keeping and storing a substrate, a door device for selectively opening and closing an opening, such as a substrate carry-in port, formed in a chamber, and the like. For example, the robot 30 may be transformed into various types of robots that perform a preset movement (motion) by using an actuator, such as a motor. Hereinafter, the present invention will be described as an example in which a robot 30 is a transfer robot that has a hand holding a substrate, such as a wafer, and transfers a substrate from a first position (current position, P₀) to a second position (target position, P_{y}) in semiconductor manufacturing equipment.

### [Configuration of a Robot System]

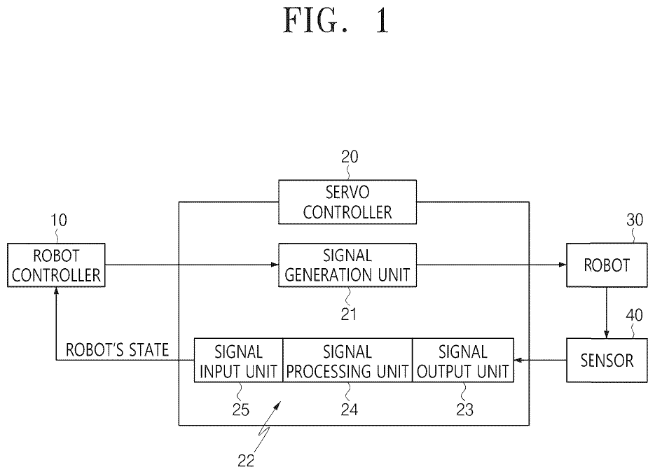

FIG. 1 is a block diagram illustrating a configuration of a robot system of the present invention.

Referring to FIG. 1, the robot system of the present invention may include a robot controller 10, a servo controller 20, a robot 30, and a sensor 40.

The robot controller 10 may design and generate a motion profile MP for the operation of the robot 30. The robot controller 10 may receive scheduled information from a controller higher than the robot controller 10, for example, a CTC, and generate a motion profile MP for operating the robot from the information.

The robot 30 may be controlled by the motion profile MP designed and generated by the robot controller 10. The robot controller 10 may generate a motion profile MP based on information (e.g., vibration information) generated based on an observed value collected by a sensor 40 to be described later. The motion profile MP may include a profile regarding a position, velocity, acceleration, and the like related to the operation of the robot 30. For example, the motion profile MP generated by the robot controller 10 may include a position profile, a velocity profile, an acceleration profile, a jerk profile, and a snap profile of the hand 32 of the robot 30. The jerk profile is a profile representing a change in acceleration, and may be a profile of a higher order than the acceleration profile. The snap profile is a profile representing a change in jerk, and may be a profile of a higher order than the jerk profile. Position-velocity-acceleration-jerk-snap may be in a differential-integral relationship with each other.

In addition, the robot controller 10 may further include an Input Shaping Technique (IST) in the form of a filter. The IST may mean a technology for pre-adjusting an input signal to reduce vibration or dynamic response of a system. This may serve to increase the accuracy and stability of the robot by optimizing an input signal to achieve a target position and a velocity profile of the robot. The IST may reduce vibration that may be generated by the operation of the robot 30.

The implementation method of the IST may be various. Various methods, from a simple Finite Impulse Response (FIR) filter to a more complex algorithm-based filter, may be used. These filters are designed based on a predefined vibration mode and system characteristics, and adjust the operation of the robot by processing an input signal in real time. When the IST is used, motion control of the robot 30 becomes more precise, and unnecessary vibration may be suppressed. This may be particularly useful in a semiconductor manufacturing process requiring high-precision work. The robot controller 10 may increase the accuracy and work efficiency of the robot 30 by generating an optimized input signal through the IST and controlling the operation of the robot 30.

The motion profile generated by the robot controller 10 is transmitted to the servo controller 20. The servo controller 20 generates a movement signal for controlling the motor of the robot 30 based on the motion profile received from the robot controller 10. The servo controller 20 may generate a current command that may be transmitted to the motor of the robot 30 with reference to the motion profile MP generated by the robot controller 10.

The servo controller 20 may include a signal generation unit 21 and an information collection unit 22. The information collection unit 22 includes a signal input unit 23, a signal processing unit 24, and a signal output unit 25.

The signal generation unit 21 generates a movement signal for controlling an actuator, such as a motor, that may be provided by the robot 30 based on the motion profile MP generated by the robot controller 10. The movement signal may generate a current signal for operating a motor that may be provided by the robot 30, based on the motion profile.

The signal input unit 23 receives an observed value of a substrate vibration VI collected by the sensor 40 installed in the robot 30. The signal processing unit 24 processes the observed value of the substrate vibration VI received by the signal input unit 23 to convert the processed observed value into vibration information VF that may be recognized by the robot controller 10. The signal output unit 25 transmits the converted vibration information VF to the robot controller 10. Here, the substrate vibration VI may be a vibration based on the vibration of the robot 30. The substrate vibration VI may be a vibration transmitted to the substrate W as the robot 30 vibrates. The robot vibration 30 and the substrate vibration VI may have the same frequency. The information collection unit 22 may derive a natural frequency of the robot 30 based on the substrate vibration VI observed by the sensor 40.

The robot controller 10 may control the operation of the robot 30 through the servo controller 20. The robot controller 10 controls the operation of the robot 30 by transmitting the motion profile to the servo controller 20, and the robot 30 may move according to a path and velocity specified in the motion profile. Necessary modifications may be made through a feedback loop between the servo controller 20 and the robot controller 10 in real time while a task is being performed.

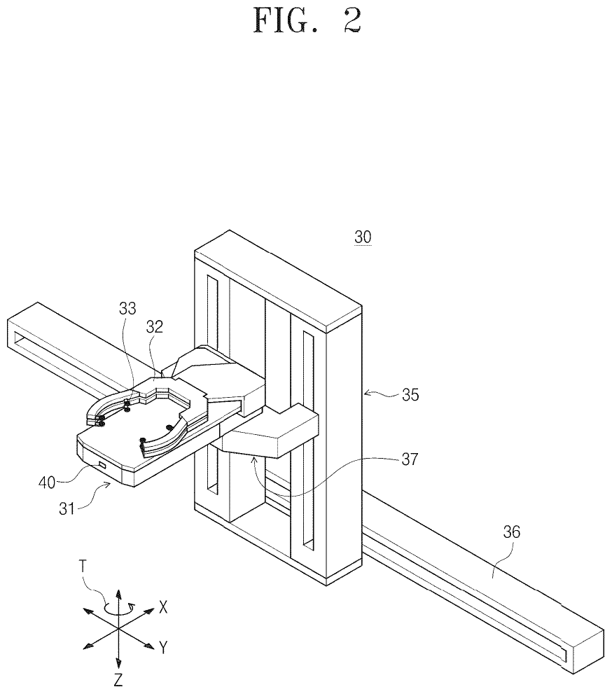

FIG. 2 is a diagram for describing the robot of FIG. 1 and the sensor installed in the robot, and FIG. 3 is a diagram for describing an example of an operation of the robot of FIG. 1.

Referring to FIGS. 2 and 3, the robot 30 may be a transfer robot capable of transferring the substrate W, such as a wafer. The robot 30 may be provided to semiconductor manufacturing equipment that manufactures semiconductor devices.

The robot 30 may be formed of several components to perform various tasks. The robot 30 includes a base 31 supporting the basic structure, and the base 31 may be moved and rotated by a vertical driver 35, a horizontal driver 36, and a rotation driver 37.

The base 31 of the robot 30 may be moved in the third direction Z by the vertical driver 35. The vertical driver 35 includes at least one guide rail extending in the third direction Z together with an actuator, such as a motor, so as to adjust the height of the base 31. The horizontal driver 36 may move the base 31 in the second direction Y, and the horizontal driver 36 may also include an actuator, such as a motor, and at least one guide rail extending in the second direction Y. Accordingly, the position of the substrate W placed on the hand 32 may be precisely adjusted. The rotation driver 37 may rotate the base 31 with respect to a vertical axis T parallel to the third direction Z, and allow the robot 30 to adjust the direction of the substrate W. Examples of actuators that may be used herein include stepping motors, servo motors, linear actuators, and the like. These actuators may perform precise control, thereby supporting precise operation of the robot.

A plurality of hands 32 is installed on the base 31, and each of the hands 32 may be designed to hold the substrate W. The hands 32 may move back and forth along the first direction X, thereby holding and moving the substrate W at various positions. An adsorption part 33 provided in each hand 32 may function to adsorb and fix the substrate W.

A plurality of hands 32 may move back and forth from a first position P₀ (current position) to a second position P_{y} (target position). The first position P₀ may refer to a position at which the hand 32 has retreated, and the second position P_{y} may refer to a position at which the hand 32 has moved forward. An example of the second position P_{y} may include a center position of a support chuck 53 supporting the substrate W in an inner space 51 of a process chamber 50 processing the substrate W. A plurality of support pins 54 may be provided in the support chuck 53 to support the substrate W positioned at the second position P_{y}. When moving forward and backward, the hand 32 may move forward and backward through a carrying-in port 52 which is an opening formed in the chamber 50. Accordingly, the hand 32 may accurately position the substrate W.

The components of the robot 30 may be controlled by the robot controller 10. The robot controller 10 may precisely control a movement path, velocity, acceleration, and the like of the robot 30 by designing a motion profile, and may minimize vibration that may occur during work. Accordingly, the robot 30 may exhibit efficient and stable performance in high-precision work, such as a semiconductor manufacturing process.

The sensor 40 may be installed at a position capable of effectively observing the substrate vibration VI that may occur while the hand 32 performs the operation of moving the substrate W. The sensor 40 may be installed at the base 31. Alternatively, the sensor 40 may be installed at the hand 32. The present invention is not limited thereto, and may be installed at a position capable of effectively observing the vibration of the substrate W among the components of the robot 30 described above, and the installation position thereof may be variously modified.

Referring back to FIG. 1, the sensor 40 detects vibration generated during the operation of the robot in real time and transmits the detected vibration to the signal input unit 23. The sensor 40, which is an observation sensor, may be a high-sensitivity sensor capable of accurately measuring vibration of a substrate, and thus, an operation state of the robot may be precisely monitored. For example, an accelerometer, a gyroscope, a laser Doppler vibrator, or a piezoelectric sensor may be used.

Based on the observed value of the substrate vibration VI measured by the sensor 40, the robot controller 10 may design an optimal motion profile MP capable of maximally suppressing the vibration that may occur when the robot 30 operates. Accordingly, the robot controller 10 may minimize unnecessary vibration generated during the operation of the robot and ensure a more stable and precise operation.

The observed value of the substrate vibration VI observed by the sensor 40 may be transmitted to the servo controller 20. The servo controller 20 may convert the observed value of the substrate vibration VI into the form of the vibration information VF as described above, and transmit the converted vibration information VF to the robot controller 10. For example, when the servo controller 20 processes the observed value of the substrate vibration VI, through this, the natural frequency fₙ related to the operation of the robot 30 may be derived. The natural frequency fₙ related to the operation of the robot 30 may be transmitted to the robot controller 10.

In addition, information transmission between the robot controller 10, the servo controller 20, the robot 30, and the sensors 40 and transmission of control signals may be performed in various ways, such as wired or wireless way. For example, a cable that transmits an electrical signal, and an optical fiber cable may be used as a wired transmission method, and Wi-Fi, Bluetooth, and radio frequency (RF) communication may be used as a wireless transmission method. This transmission method may be selected according to the requirements of the robot control system, and each method needs to consider the transmission distance, data transmission velocity, signal interference, and the like.

The robot controller 10 and the servo controller 20 may be implemented in various forms. For example, the robot controller 10 and the servo controller 20 may be implemented as a hardware device including a circuit, a substrate, and the like. Such a hardware configuration may include a high performance microprocessor, a memory, an input/output port, and other essential electronic components. Also, the robot controller 10 and the servo controller 20 may be implemented as a software program executed in a computer system or an embedded system. The robot controller 10 and the servo controller 20 implemented as software may consist of an algorithm that performs a specific task and a program code for data processing, which is stored and executed in a memory of a computer.

### [Control Method for a Robot System]

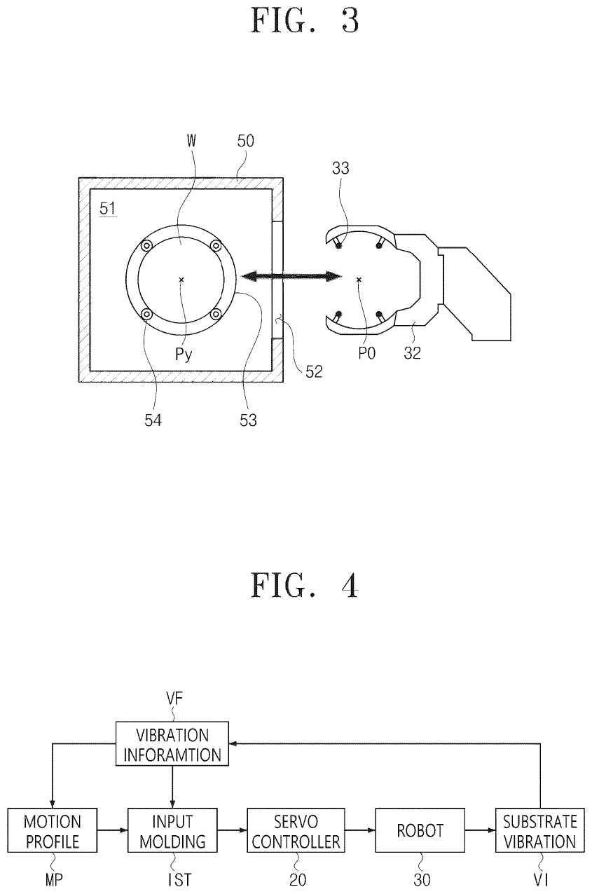

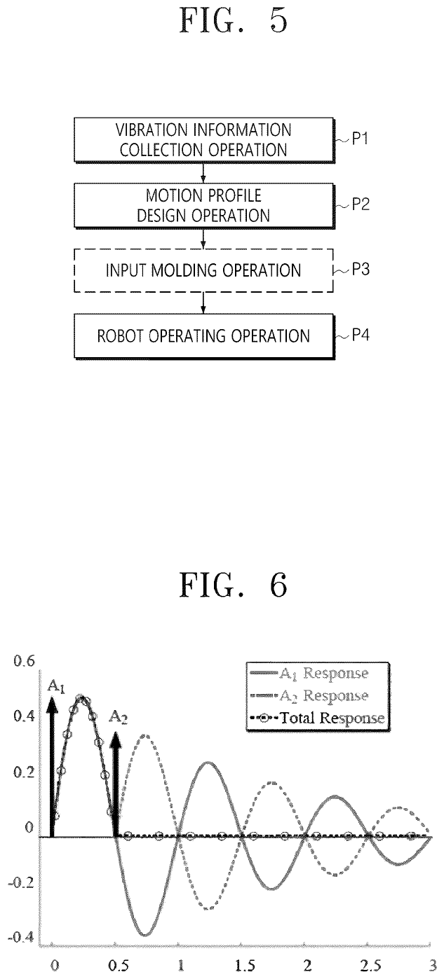

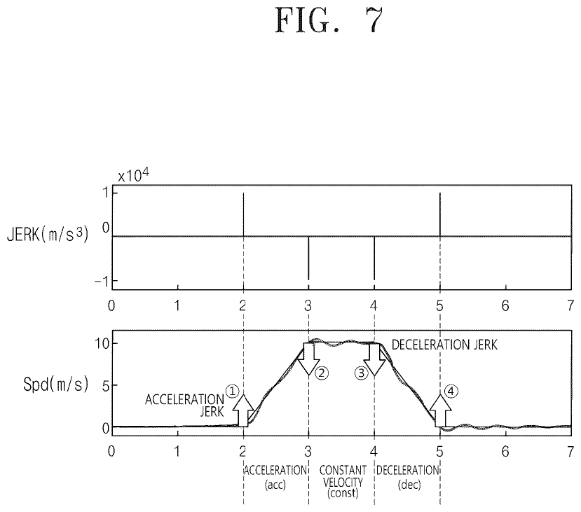

FIG. 4 is a block diagram for describing a method of controlling an operation of the robot by observing a vibration of the substrate of FIG. 1, and FIG. 5 is a flowchart illustrating a control method for a robot system according to an exemplary embodiment of the present invention.

Referring to FIGS. 4 and 5, a control method for a robot system according to an exemplary embodiment of the present invention may include a vibration information collection operation P1, a motion profile design operation P2, an input molding operation P3, and a robot operating operation P4.

In the vibration information collection operation P1, an observed value of vibration occurring when the robot 30 operates may be collected. For example, in the vibration information collection operation P1, the substrate vibration VI generated on the substrate W placed on the robot 30 may be observed through the sensor 40 attached to the robot 30. The observed values collected by the sensor 40 may be observed in the same form as a change in the position of the substrate W over time. Also, in the vibration information collection operation P1, the observed values collected by the sensor 40 may be transmitted to the information collection unit 22. The information collection unit 22 processes the observed values collected by the sensor 40, and through this, the robot controller 10 may derive a natural frequency fₙ, which is the vibration information VF to be used when the motion profile MP is designed. The natural frequency fₙ may mean the natural frequency fₙ of vibration generated on the substrate W when the robot 30 operates. Here, the operation of the robot 30 may be an operation in which the hand 32 moves from the first position P₀ to the second position P_{y}, or may be an operation in which the hand 32 moves from the second position P_{y} to the first position P₀.

In the motion profile design operation P2, the motion profile MP to be applied when the robot 30 operates in the robot operating operation P4 may be designed. A specific design method of the motion profile MP will be described later.

The input molding operation P3 may generate a command optimized for vibration reduction of the robot 30 by using a filter specialized for vibration reduction called an Input Shaping Technique (IST) included in the robot controller 10.

As described above, vibration reduction using IST is distinguished from the design of the motion profile MP to be described later. A general mechanical system uses IST for vibration control. For example, when an A₂ response smaller than an A₁ response is generated after a half cycle of the A₁ response in order to offset the vibration generated by the A₁ response, as illustrated in FIG. 6, the vibration of the mechanical system may be reduced while the vibration by the A₁ response is offset by the A₂ response. In other words, the IST uses the time delay effect, and when the IST is applied to a robot system where production is important, for example, a robot system applied to semiconductor manufacturing equipment, there is a risk that production will be lowered. The actual robot system is a multi-mode system (with several vulnerable frequencies), and several ISTs needs to be applied to remove all of them, and the time delay effect increases by the amount.

That is, the method of designing the motion profile MP described below is a method of improving the vulnerable frequency of the system without a time delay, such as IST, and may be distinguished from the IST. Therefore, when the motion profile design method of the present invention is used, the input molding operation P3 may be omitted according to the user's selection.

In the robot operating operation P4, the servo controller 20 receives the motion profile MP generated by the robot system 10, and the servo controller 20 may generate a control signal (e.g., a current signal) for controlling the actuator(s) of the robot 30 so that the robot 30 may move according to the motion profile MP. By the control signal generated by the servo controller 20, the robot 30 may move according to the motion profile MP.

When the robot 30 operates according to the motion profile MP, new substrate vibration VI may be generated by the sensor 40. The substrate vibration VI may be observed by the sensor 40, and the observed value observed by the sensor 40 may be processed as the vibration information VF, which is the natural frequency fₙ, through the servo controller 20 and transmitted to the robot controller 10.

The robot controller 10 may generate the updated motion profile MP again based on the received natural frequency fₙ.

### [Method of Designing a Motion Profile]

Hereinafter, a specific design method of the motion profile MP generated by the robot controller 10 will be described in detail. First, before a design method of the motion profile MP of the present invention is described, a concept of a jerk will be described.

FIG. 7 is a graph for describing a main cause of generating vibration in a robot.

Referring to FIG. 7, in general, a trapezoidal velocity profile MP is used to implement the operation of the robot 30. The trapezoidal velocity profile MP may be a velocity profile MP including an acceleration section, a (optional) constant velocity section, and a deceleration section. Optionally, including a constant velocity section may also include a case where the length of the constant velocity section is 0.

When the velocity command is applied to the secondary system, the robot vibrates and follows the system's natural frequency. Referring to FIG. 7, the jerk in the positive direction is generated at \textcircled{1}, and the jerk in the negative direction is generated at \textcircled{2}. In the velocity graph, vibration starts in the form of overshooting for the command based on the velocity motion profile based on the time points of \textcircled{1} and \textcircled{2} (in FIG. 7, vibration is indicated by a thick solid line, and the velocity profile is indicated by a thin solid line). For a jerk occurring at the time point of \textcircled{1}, the jerk occurring at the time point of \textcircled{2} may be a counter jerk. The jerk occurring at the time point of \textcircled{1} may be the main jerk, and the jerk occurring at the time point of \textcircled{2} may be the counter jerk.

In addition, the jerk in the negative direction is applied at \textcircled{3} and the jerk in the positive direction is applied at \textcircled{4} symmetrically to \textcircled{1} and \textcircled{2} based on the center of the constant velocity section. Similar to the above, vibration starts in the form of overshooting for the command based on the velocity motion profile based on the time points of \textcircled{3} and \textcircled{4}. For the jerk applied at the time point of \textcircled{3}, the jerk applied at the time point of \textcircled{4} may be the counter jerk. The jerk applied at the time point of \textcircled{3} may be the main jerk, and the jerk applied at the time point of \textcircled{4} may be the counter jerk.

In other words, it can be seen that the vibration generated by the operation of the robot 30 determines the vibration response and vibration form of the robot system according to the pattern of the jerk, not the pattern of the velocity profile.

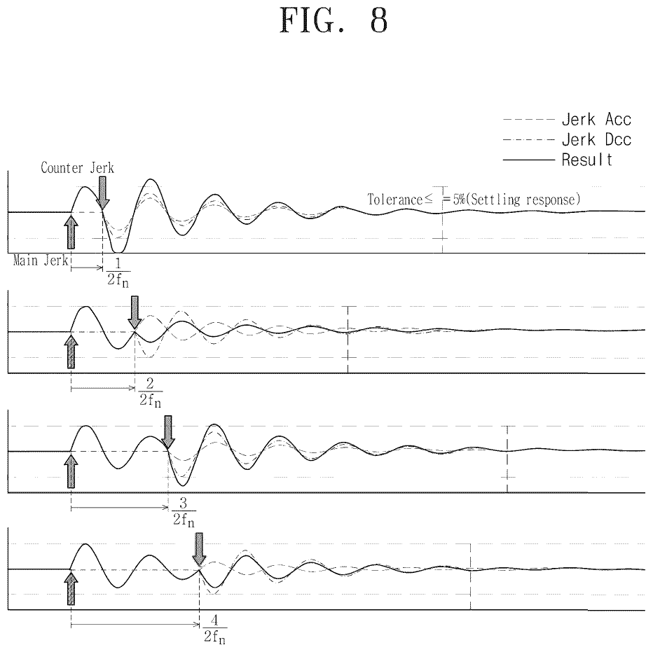

FIG. 8 is a graph illustrating a comparison of residual vibration response forms according to a time point of application of a counter jerk for a main jerk.

Referring to FIG. 8, each of the four graphs from top to bottom illustrates a change in vibration over time. In addition, in all four graphs, the main jerk of the same size was oscillated at the same time, but the application time of the counter jerk was different. In this case, the sizes of the applied counter jerk were all set to be the same.

As illustrated in FIG. 8, in each case shown in the four graphs, vibration overlaps or offsets as the counter jerk is applied, and thus the cases have different response characteristics. It can be seen that among the four graphs, the case corresponding to the second graph has the shortest setting time.

In other words, the present invention proposes a method of designing a motion profile MP optimized for vibration reduction based on the jerk shape generated by the motion profile of the robot 30 as described above.

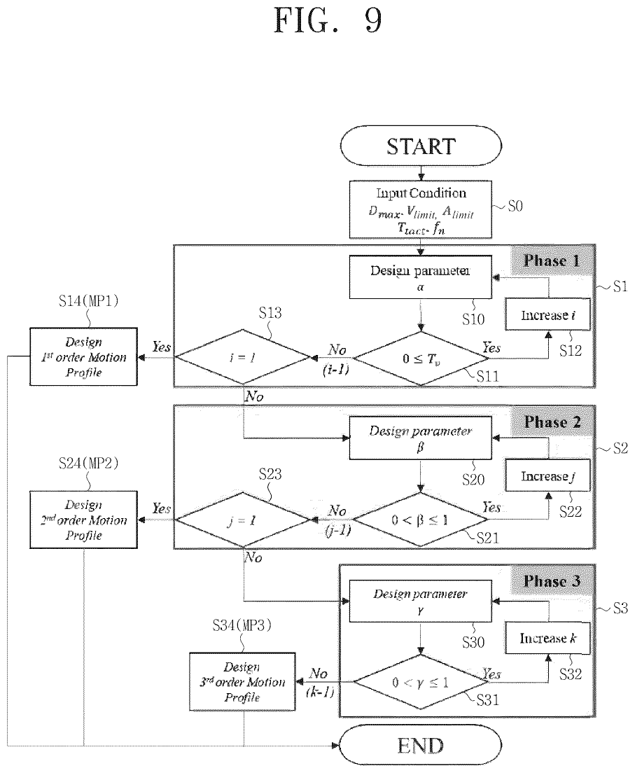

FIG. 9 is a flowchart illustrating a method of designing a motion profile according to an exemplary embodiment of the present invention.

FIG. 9 illustrates a flowchart of an algorithm for designing a motion profile MP according to an exemplary embodiment of the present invention. The algorithm illustrated in FIG. 9 may be implemented through the robot controller 10. The algorithm illustrated in FIG. 9 may be implemented by a program stored on a recording medium that the robot controller 10 may have. Accordingly, the robot controller 10 may be provided with a recording medium and at least one processor capable of implementing a program stored on the recording medium. Through the algorithm illustrated in FIG. 9, a single motion profile MP optimized for vibration reduction may be generated.

Hereinafter, the present invention will be described based on the case where the motion profile MP for the above-described forward operation of the robot 30 is designed as an example. The forward operation may be an operation of moving the hand 32 of the robot 30 from the first position P₀ to the second position P_{y}. Also, hereinafter, the present invention will be described based on the case where the generated motion profile MP is the velocity motion profile as an example.

In operation S0, the user may input basic design parameters that are limiting conditions for designing the motion profile MP. The design parameters input in advance may be operating time T_{tact}, movement distance (stroke) Dₘₐₓ, natural frequency fₙ, limit velocity Vₗᵢₘᵢₜ, and limit acceleration Aₗᵢₘᵢₜ.

The operating time T_{tact} may mean a time when an actuator, for example, a motor, of the robot 30 is driven. For example, the operating time T_{tact} may be a time that the hand 32 of the robot 30 has to be satisfied to move from the first position P₀ to the second position P_{y}. The motion profile MP generated through the above-described algorithm is designed so that the time required for the hand 32 to move may satisfy the operating time T_{tact} input as a design condition.

The movement distance Dₘₐₓ may be a distance by which the object moves by driving the actuator of the robot 30. For example, the movement distance Dₘₐₓ may be a distance by which the hand 32 moves, that is, a distance from the first position P₀ to the second position P_{y}. The motion profile generated through the above-described algorithm is designed so that the distance the hand 32 moves may satisfy the movement distance Dₘₐₓ input as the design condition.

The natural frequency fₙ may be derived based on the vibration observed value collected by the sensor 40 described above.

The limited velocity Vₗᵢₘᵢₜ and the limited acceleration Aₗᵢₘᵢₜ may reflect specifications of the motor of the robot 30 driven by the motion profile MP. That is, the motion profile MP is designed so that the velocity and acceleration of the hand 32 operating according to the motion profile MP do not exceed the limit velocity Vₗᵢₘᵢₜ and the limit acceleration Aₗᵢₘᵢₜ input as the design conditions.

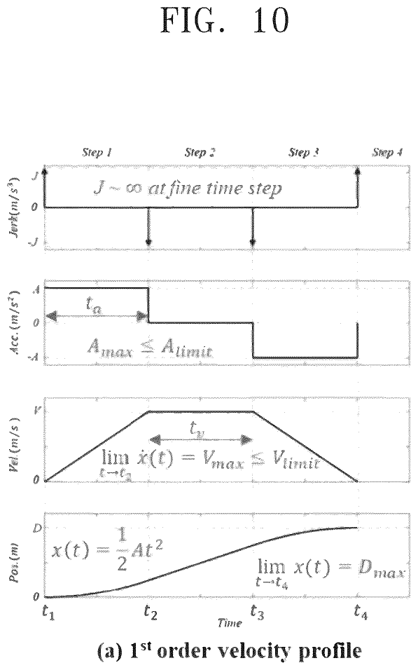

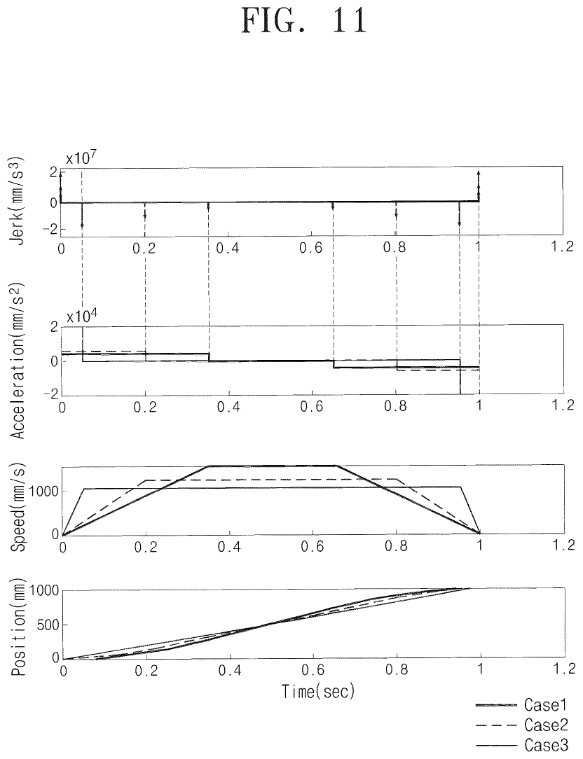

FIG. 10 is graphs illustrating the first order motion profile generated by the primary vibration coefficient. The first order motion profile may mean a profile that generates a jerk in an impact form.

Referring to FIGS. 9 and 10, in operation S1, a first order velocity motion profile may be designed. In operation S1, a primary vibration coefficient α may be designed, and a first order velocity motion profile may be designed based the designed primary vibration coefficient α.

The primary vibration coefficient α may be defined as follows. The natural frequency fₙ may be derived based on the observed value observed in advance by the sensor 40. The natural frequency fₙ may be the natural frequency fₙ generated during the above-described forward operation by the hand 32 of the robot 30.

$$α = \frac{i}{{f}_{n}} , ( i = 1 , 2 , 3 , … )$$

fₙ: Natural frequency
i: Natural number of 1 or more

In operation S10, primary vibration coefficient α may be temporarily designed. In this case, the algorithm may temporarily design the primary vibration coefficient α while sequentially increasing i from 1.

In operation S11, it is checked whether a condition preset by the first order velocity profile MP1 generated by the temporarily designed primary vibration coefficient α, for example, the length tᵥ of the constant velocity section, is 0 or more.

For example, when i is 1, the temporarily designed primary vibration coefficient α becomes 1/fₙ. In this case, in operation S11, the first order motion profile MP1 is temporarily generated based on the temporarily designed primary vibration coefficient α, and it is checked whether the length tᵥ of the constant velocity section of the generated first order motion profile MP1 is 0 or more.

A form of the profile generation function of the first order velocity motion profile MP1 may be as follows.

### (Form of the Generation Function of the First Order Velocity Profile)

$$Profile\_Speed \_ 1 st ( {P}_{0} , {P}_{y} , {V}_{max} , {A}_{acc} , {A}_{dec} , dt ) ;$$

P₀: Current location
P_{y}: Target location
Vₘₐₓ: Maximum velocity
A_{acc}: Acceleration section maximum acceleration
A_{dec}: Deceleration section maximum deceleration
dt: Update period. This may be input as a time step, such as 0.001 seconds or 0.01 seconds.

Here, a motion profile in a symmetrical form, such as a trapezoidal velocity motion profile, may mean A_{acc}=A_{dec}=Aₘₐₓ.

The boundary condition of the first order velocity motion profile MP1 may be as follows.

### (Boundary Condition for First Order Velocity Profile)

$${t}_{a} = {V}_{max} / {A}_{max}$$

$${t}_{v} = {D}_{max} / {V}_{max} - {t}_{a}$$

$${D}_{max} = {V}_{max} ( {t}_{a} + {t}_{v} )$$

tₐ: Constant acceleration section length
tᵥ: Constant velocity section length
Vₘₐₓ: Maximum velocity
Aₘₐₓ: Maximum acceleration
Dₘₐₓ: Movement distance

The primary vibration coefficient α may be 1/fₙ. That is, the primary vibration coefficient α may be a reciprocal number of the natural frequency. This may mean a natural vibration period. The natural vibration period may mean, for example, a time interval from the time point when the main jerk occurs to the time point when the counter jerk occurs. In other words, the primary vibration coefficient α may mean a length from the time point when the acceleration section starts to the time point when the acceleration section ends, that is, the acceleration section length tₐ.

In the boundary condition of the first order velocity motion profile MP, the acceleration section length tₐ is 1/fₙ, which is the primary vibration coefficient α, and Dₘₐₓ is a pre-input design parameter. Therefore, the maximum velocity Vₘₐₓ, the maximum acceleration Aₘₐₓ, and the constant velocity section length tᵥ may be calculated using the foregoing three polynomials.

In this case, since the calculated length of the constant velocity section tᵥ cannot be less than 0, only when the length of the constant velocity section tᵥ is greater than or equal to 0 in operation S11, operation S12 proceeds to increase the value of i. For example, referring to an example illustrated in FIG. 11, i may be 1 in Case 1, i may be 2 in Case 2, and i may be 3 in Case 3.

As the value of i increases, the primary vibration coefficient α increases. For example, the primary vibration coefficient α increases from 1/fₙ to 2/fₙ. This may mean that the acceleration section length tₐ becomes longer. Since the movement distance Dₘₐₓ input in advance as the design parameter is already determined, even if the acceleration section length tₐ becomes longer, the lower area of the first order velocity profile MP1 needs to be constant as the movement distance Dₘₐₓ. That is, increasing the value of i may mean not only that the acceleration section length tₐ becomes longer, but also that the magnitude of the maximum acceleration Aₘₐₓ becomes small and the maximum velocity Vₘₐₓ becomes large in the acceleration section. In this case, the maximum velocity Vₘₐₓ cannot exceed the limit velocity Vₗᵢₘᵢₜ which is a design parameter input in advance. It may be seen that when the magnitude of the maximum acceleration Aₘₐₓ becomes smaller, the magnitude of the jerk becomes smaller, and thus the magnitude of the generated vibration also becomes smaller.

Referring back to FIGS. 9 and 10, when it is confirmed that the length tᵥ of the constant velocity section of the temporarily generated first order motion profile MP1 is 0 or more, operation S12 proceeds, otherwise operation S13 proceeds.

When operation 12 proceeds, the value of i is increased and the primary vibration coefficient α is temporarily designed again. Then, the first order motion profile MP1 is temporarily generated again, and it is checked whether the length of the constant velocity section tᵥ of the generated motion profile MP1 is equal to or greater than 0. When the length of the constant velocity section tᵥ is equal to or greater than 0, operation S12 proceeds again, and when the length of the constant velocity section tᵥ is less than 0, operation S13 proceeds.

In operation S13, a value (i.e., a value with −1) reduced by 1 from the value of i input in operation S11 is determined as the final value of i. That is, in operation S13, the final primary vibration coefficient α may be determined. When the determined value of i is 1, operation S14 is immediately performed to generate the first order velocity motion profile MP1 as a final motion profile MP. In this case, the generated first order velocity motion profile MP1 may have a profile form as illustrated in FIG. 10.

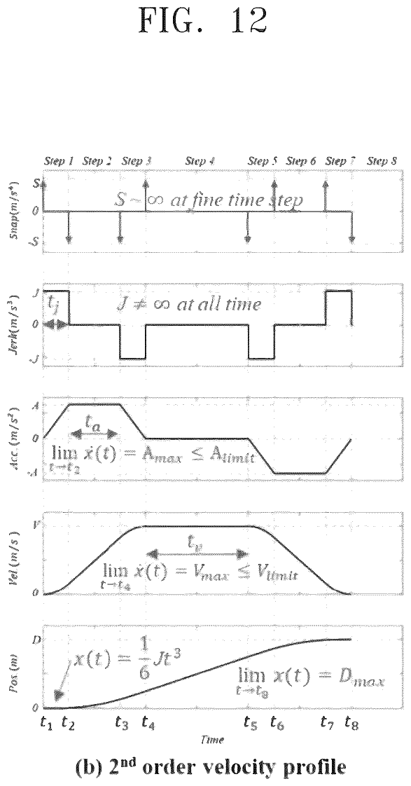

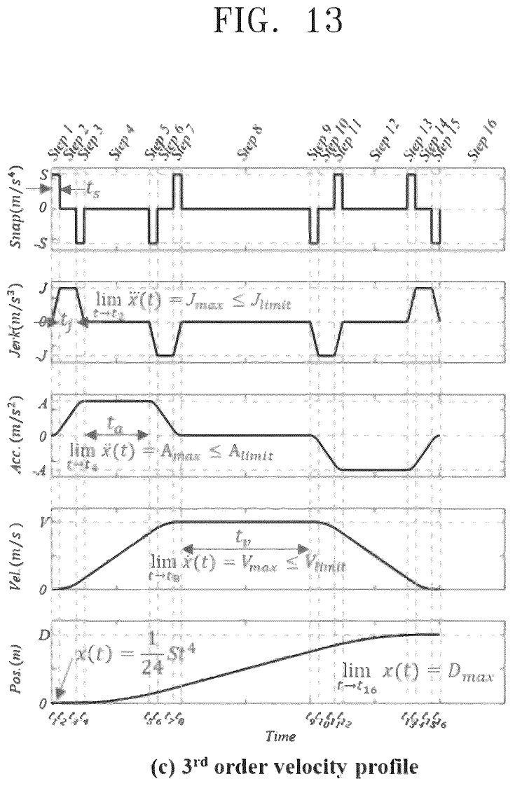

FIG. 12 is graphs illustrating the second order motion profile generated by the primary vibration coefficient and a secondary vibration coefficient. The second order motion profile may refer to a profile that generates a jerk in a rectangular area shape.

Referring to FIGS. 9 and 12, in operation S2, a second order velocity motion profile may be designed. In operation S2, a secondary vibration coefficient β may be designed, and a second order velocity motion profile may be designed based on the designed second order velocity motion profile. The second order velocity motion profile designed herein may be generated based on the first order velocity motion profile.

In operation S2, the secondary vibration coefficient β may be designed. The secondary vibration coefficient β may be defined as follows. The natural frequency fₙ may be derived based on the observed value observed in advance by the sensor 40. The natural frequency fₙ may be the natural frequency fₙ generated during the above-described forward operation by the hand 32 of the robot 30. The primary vibration coefficient α may be derived in operation S1.

$$β = 2 \frac{1}{α} \frac{j}{{f}_{n}} , ( j = 1 , 2 , 3 , … )$$

α: Primary vibration coefficient
j: Natural number of 1 or more
fₙ: Natural frequency

In operation S20, the secondary vibration coefficient β may be designed. In this case, the algorithm may temporarily design the secondary vibration coefficient β while sequentially increasing j from 1.

In operation 21, it is checked whether the secondary vibration coefficient β is a preset condition, for example, greater than 0 and equal to or less than 1.

The secondary vibration coefficient β may mean a time during which the jerk is applied compared to the acceleration section from a physical point of view. For example, in FIG. 12, the secondary vibration coefficient β may mean (Step 1+Step 3)/(Step 1+Step 2+Step 3). That is, when the secondary vibration coefficient β is 1, it means that the jerk is applied in the entire acceleration section. Conversely, when the secondary vibration coefficient β is 0, it means that the time the jerk is applied in the entire acceleration section is 0. However, since 0 for the secondary vibration coefficient β corresponds to the first order motion profile, in operation 21, it is checked whether the secondary vibration coefficient β is greater than 0 and equal to or less than 1.

In operation S21, when the secondary vibration coefficient β is greater than 0 and equal to or less than 1, operation S22 is performed, and if not, operation S23 is performed. When operation 22 proceeds, the value of i is increased and the primary vibration coefficient α is temporarily designed again. Then, it is checked whether the temporarily designed secondary vibration coefficient β satisfies the condition greater than 0 and equal to or less than 1, and if not, operation S23 proceeds.

In operation S23, a value obtained by setting −1 from the value of j input in operation S21 is determined as a final value of j. That is, in operation S23, a final secondary vibration coefficient β may be determined. When the determined value of j is 1, the second velocity motion profile MP2 is generated as a final motion profile MP by immediately proceeding to operation S24. In this case, the generated second order velocity motion profile MP2 may have the form of a profile as illustrated in FIG. 12.

A form of the profile generation function of the second order velocity motion profile MP2 may be as follows.

### (Form of the Generation Function of the Second Order Velocity Profile)

$$Profile\_Speed \_ 2 st ( {P}_{0} , {P}_{y} , {V}_{max} , {A}_{acc} , {A}_{dec} , {J}_{acc} , {J}_{dec} , dt ) ;$$

P₀: current location
P_{y}: Target location
Vₘₐₓ: Maximum velocity
A_{acc}: Acceleration section maximum acceleration
A_{dec}: Deceleration section maximum deceleration
J_{acc}: Jerk in acceleration section
J_{dec}: Jerk in deceleration section
dₜ: Update period. This may be input as a time step, such as 0.001 seconds or 0.01 seconds.

Here, like a trapezoidal velocity motion profile, a symmetrical motion profile may mean A_{acc}=A_{dec}=Aₘₐₓ, and J_{acc}=J_{dec}=Jₘₐₓ. Depending on the expression method, J_{acc}, J_{dec} may be expressed as a ratio of time or an actual physical quantity.

When the ratio for time is used, it may mean J_{acc}=J_{dec}=β. It may be β=2tⱼ/(2tⱼ+tₐ). In the generation step, since an actual physical quantity is required for a polynomial configuration, β may be converted into an actual physical quantity Jₘₐₓ.

The boundary condition of the second order velocity motion profile MP2 may be as follows.

### (Boundary Condition for Second Order Velocity Profile)

$${t}_{j} = β {V}_{max} / 2 {A}_{max}$$

$${t}_{a} = {V}_{max} / {A}_{max} ( 1 - β )$$

$${t}_{v} = ( {D}_{max} - {V}_{max}^{2} / {A}_{max} ) / {V}_{max}$$

$${D}_{max} = {V}_{max} ( 2 {t}_{j} + {t}_{a} + {t}_{v} )$$

$${A}_{max} = {A}_{ref} / ( 1 - 1 / 2 β )$$

$${J}_{max} = {A}_{max} / {t}_{j}$$

β: Secondary vibration coefficient
tⱼ: Length of the jerk section
tₐ: Constant acceleration section length
tᵥ: Constant velocity section length
Vₘₐₓ: Maximum velocity
Aₘₐₓ: Maximum acceleration
Dₘₐₓ: Movement distance
Jₘₐₓ: Maximum jerk
A_{ref}: Reference acceleration

The secondary vibration coefficient β used in calculating the jerk section length tⱼ, the constant acceleration section length tₐ, and the constant velocity section length tᵥ may be the coefficient determined in operation S23.

The maximum acceleration Aₘₐₓ and the maximum velocity Vₘₐₓ used in calculating the jerk section length tⱼ, the constant acceleration section length tₐ, and the constant velocity section length tᵥ may be values finally determined in operation S1. This is because the second order velocity motion profile MP2 is generated based on the first order velocity motion profile MP1.

As for the jerk section length tⱼ, the constant acceleration section length tₐ, and the constant velocity section length tᵥ used in calculating the movement distance Dₘₐₓ, the values calculated previously (i.e., the values calculated in operation S2) may be used, and as for the maximum velocity Vₘₐₓ, a value finally determined in operation S1 may be used. In this case, the movement distance Dₘₐₓ satisfies a value preset as a design condition.

As for the reference acceleration A_{ref} used in calculating the maximum acceleration Aₘₐₓ, the value of the maximum acceleration Aₘₐₓ finally determined in operation S1 may be used.

As for the jerk section length tⱼ and the maximum acceleration Aₘₐₓ used in calculating the maximum jerk Jₘₐₓ, the previously calculated value (i.e., the value calculated in operation S2) may be used.

Since the jerk section length tₐ, the constant acceleration section length tₐ, and the constant velocity section length tᵥ were obtained, and the maximum jerk Jₘₐₓ in the jerk section, the maximum acceleration Aₘₐₓ in the constant acceleration section, and the maximum velocity Vₘₐₓ in the constant velocity section were obtained, the second velocity motion profile MP2 may be derived based on them.

Specifically, in the jerk section, the second order velocity motion profile MP2 may be derived by integrating the maximum jerk Jₘₐₓ twice. In the constant acceleration section, the second velocity motion profile MP2 may be derived by integrating the maximum acceleration Aₘₐₓ once. In the constant velocity section, the second velocity motion profile MP2 may be derived by applying the maximum velocity Vₘₐₓ itself.

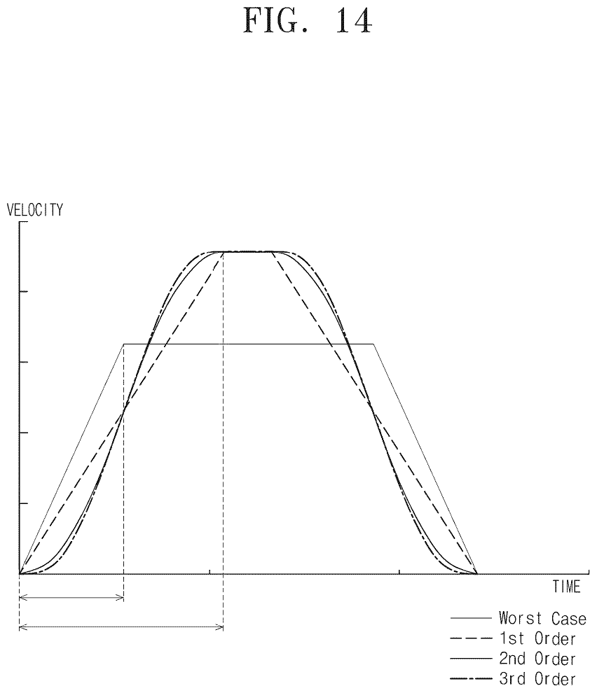

FIG. 13 is graphs illustrating a method of designing a third order motion profile of FIG. 9. The third order motion profile may mean a profile that generates a jerk in a trapezoidal area shape.

Referring to FIGS. 9 and 13, in operation S3, a third order velocity motion profile may be designed. In operation S3, a tertiary vibration coefficient γ may be designed, and a third order velocity motion profile may be designed based on the designed tertiary vibration coefficient γ. The third order velocity motion profile designed here may be generated based on the second order velocity motion profile.

In operation S3, a tertiary vibration coefficient γ may be designed. The tertiary vibration coefficient α may be defined as follows. The natural frequency fₙ may be derived based on the observed value observed in advance by the sensor 40. The natural frequency fₙ may be the natural frequency fₙ generated during the above-described forward operation by the hand 32 of the robot 30. The primary vibration coefficient α may be derived in operation S1, and the secondary vibration coefficient β may be derived in operation S2.

$$γ = 4 \frac{1}{α β} \frac{k}{{f}_{n}} , ( k = 1 , 2 , 3 , … )$$

α: Primary vibration coefficient
β: Secondary vibration coefficient
k: Natural number of 1 or more
fₙ: Natural frequency

In operation S30, a tertiary vibration coefficient γ may be designed. In this case, the algorithm may temporarily design the tertiary vibration coefficient γ while sequentially increasing k from 1.

In operation 31, it is checked whether the tertiary vibration coefficient γ is a preset condition, for example, greater than 0 and equal to or less than 1.

The tertiary vibration coefficient γ may mean a time during which the snap is applied compared to the jerk section from a physical point of view. For example, in FIG. 13, the tertiary vibration coefficient γ may mean (Step 1±Step 3)/(Step 1+Step 2+Step 3). That is, when the tertiary vibration coefficient γ is 1, it means that the snap is applied in the entire jerk section. Conversely, when the tertiary vibration coefficient γ is 0, it means that the time the snap is applied in the entire jerk section is 0. However, since 0 for the tertiary vibration coefficient γ corresponds to the second order motion profile, in operation 31, it is checked whether the tertiary vibration coefficient γ is greater than 0 and equal to or less than 1.

In operation S31, when the tertiary vibration coefficient γ is greater than 0 and equal to or less than 1, operation S32 proceeds.

When operation 32 proceeds, the value of k is increased and the tertiary vibration coefficient γ is temporarily designed again. Then, it is checked whether the temporarily designed tertiary vibration coefficient γ satisfies the condition greater than 0 and equal to or less than 1, and if not, operation S34 proceeds.

In operation S34, a value obtained by setting −1 from the value of k input in operation S31 is determined as a final value of k. That is, in operation S34, the final tertiary vibration coefficient γ may be determined. In addition, based on the tertiary vibration coefficient γ determined in operation S34, the third order velocity motion profile MP3 is generated as the final motion profile MP. In this case, the generated third order velocity motion profile MP3 may have the form of a profile as illustrated in FIG. 13.

A form of the profile generation function of the third order velocity motion profile MP3 may be as follows.

### (Form of the Generation Function of the Third Order Velocity Profile)

$$Profile\_Speed \_ 3 st ( {P}_{0} , {P}_{y} , {V}_{max} , {A}_{acc} , {A}_{dec} , {J}_{acc} , {J}_{dec} , {S}_{acc} , {S}_{dec} , dt ) ;$$

P₀: current location
P_{y}: Target location
Vₘₐₓ: Maximum velocity
A_{acc}: Acceleration section maximum acceleration
A_{dec}: Deceleration section maximum deceleration
J_{acc}: Jerk in acceleration section
J_{dec}: Jerk in deceleration section
S_{acc}: Snap of acceleration section
S_{dec}: Snap of deceleration section
dₜ: Update period. This may be input as a time step, such as 0.001 seconds or 0.01 seconds.

Here, like a trapezoidal velocity motion profile, a symmetrical motion profile may mean A_{acc}=A_{dec}=Aₘₐₓ, J_{acc}=J_{dec}=Jₘₐₓ, and S_{acc}=S_{dec}=Sₘₐₓ. Depending on the expression method, J_{acc}, J_{dec} may be expressed as a ratio of time or an actual physical quantity. Depending on the expression method, S_{acc}, S_{dec} may be expressed as a ratio of time or an actual physical quantity.

When the ratio for time is used, it may mean J_{acc}=J_{dec}=3. It may be β=1/(1+tₐ/(4tₛ+2tⱼ)). In the generation step, since an actual physical quantity is required for a polynomial configuration, β may be converted into an actual physical quantity Jₘₐₓ. When the ratio for time is used, it may mean S_{acc}=S_{dec}=γ. It may be γ=(1/(1+tⱼ/2tₛ). In the generation step, since an actual physical quantity is required for a polynomial configuration, γ may be converted into an actual physical quantity Sₘₐₓ.

The boundary condition of the third order velocity motion profile MP3 may be as follows.

### (Boundary Condition for Third Order Velocity Profile)

$${t}_{a} = {V}_{max} β γ / 4 {A}_{max}$$

$${t}_{j} = ( {V}_{max} β ( 1 - γ ) ) / 2 {A}_{max}$$

$${t}_{a} = ( {V}_{max} ( 1 - β ) ) / {A}_{max}$$

$${t}_{v} = ( {D}_{max} - {V}_{max}^{2} / {A}_{max} ) / {V}_{max}$$

$${D}_{max} = {V}_{max} ( 4 {t}_{s} + 2 {t}_{j} + {t}_{a} + {t}_{v} )$$

$${A}_{max} = {A}_{ref} / ( 1 - 1 / 2 β )$$

$${J}_{max} = {A}_{max} / ( {t}_{s} + {t}_{j} )$$

$${S}_{max} = {A}_{max} / ( {t}_{s} ( {t}_{s} + {t}_{j} ) )$$

β: Secondary vibration coefficient
γ: Tertiary vibration coefficient
tₛ: Snap section length
tⱼ: Length of the jerk section
tₐ: Constant acceleration section length
tᵥ: Constant velocity section length
Vₘₐₓ: Maximum velocity
Aₘₐₓ: Maximum acceleration
Dₘₐₓ: Movement distance
Jₘₐₓ: Maximum jerk
A_{ref}: Reference acceleration

The tertiary vibration coefficient γ used in calculating the snap section length tₛ, the jerk section length tⱼ, the constant acceleration section length tₐ, and the constant velocity section length tᵥ may be the number of coefficients determined in operation S34, and the secondary vibration coefficient β may be the coefficient determined in operation S2.

The maximum acceleration Aₘₐₓ and the maximum velocity Vₘₐₓ used in calculating the snap section length tₛ, the jerk section length tⱼ, the constant acceleration section length tₐ, and the constant velocity section length tᵥ may be values finally determined in operation S2. This is because the third order velocity motion profile MP3 is generated based on the second order velocity motion profile MP2. In addition, the movement distance Dₘₐₓ used in calculating the snap section length tₛ, the jerk section length tⱼ, the constant acceleration section length tₐ, and the constant velocity section length tᵥ may be the preset value as design conditions.

As for the snap section length tₛ, the jerk section length tⱼ, the constant acceleration section length tₐ, and the constant velocity section length tᵥ used in calculating the movement distance Dₘₐₓ, the values calculated previously (i.e., the values calculated in operation S3) may be used, and as for the maximum velocity Vₘₐₓ, a value finally determined in operation S1 may be used. In this case, the movement distance Dₘax satisfies a value preset as a design condition.

As for the reference acceleration A_{ref} used in calculating the maximum acceleration Aₘₐₓ, the value of the maximum acceleration Aₘₐₓ finally determined in operation S2 may be used.

As for the snap section length tₛ, the jerk section length tⱼ, and the maximum acceleration Aₘₐₓ used in calculating the maximum jerk Jₘₐₓ, the previously calculated value (i.e., the value calculated in operation S3) may be used.

As for the snap section length tₛ, the jerk section length tⱼ, and the maximum acceleration Aₘₐₓ used in calculating the maximum snap Sₘₐₓ, the previously calculated value (i.e., the value calculated in operation S3) may be used.

Since the snap section length tₛ, the jerk section length tₐ, the constant acceleration section length tₐ, and the constant velocity section length tᵥ were obtained, and the maximum snap Sₘₐₓ in the snap section, the maximum jerk Jₘₐₓ in the jerk section, the maximum acceleration Aₘₐₓ in the constant acceleration section, and the maximum velocity Vₘₐₓ in the constant velocity section were obtained, the third order velocity motion profile MP3 may be derived based on them.

Specifically, in the snap section, the third order velocity motion profile MP3 may be derived by integrating the maximum snap Sₘₐₓ three times. Specifically, in the jerk section, the third order velocity motion profile MP3 may be derived by integrating the maximum jerk Jₘₐₓ twice. In the constant acceleration section, the third order velocity motion profile MP3 may be derived by integrating the maximum acceleration Aₘₐₓ once. In the constant velocity section, the third order velocity motion profile MP3 may be derived by applying the maximum velocity Vₘₐₓ itself.

FIG. 14 is a diagram illustrating an example of first order to third order velocity motion profiles generated by the method of designing the motion profile of the present invention.

Referring to FIG. 14, in the Worst case to which the method of designing the motion profile according to the exemplary embodiment of the present invention is not applied, the operation of the robot 30 is controlled by using a general trapezoidal velocity motion profile. In the method of designing the motion profile according to the exemplary embodiment of the present invention, since the jerk of the first order velocity motion profile MP1 (1^{st} order) applied up to operation S1 is less applied compared to that of the Worst case, vibration may be further reduced. In addition, the jerk of the second order velocity motion profile MP2 (2^{nd} order) applied up to operation S2 is less applied compared to the Worst case and the first order velocity motion profile MP1, so that vibration may be further reduced. Similarly, the jerk of the third order velocity motion profile MP3 applied up to operation S3 is less applied compared to the Worst case, the first order and second order velocity motion profiles MP1 and MF2, so that vibration may be further reduced.

### Examples of Generating a First Order Velocity Profile

When the contents of Table 1 below are input as design parameters, the main coefficients of the generated velocity profile are shown in Table 2.

TABLE 1
Case 1

| Input Condition | Value | |
|---|---|---|
| Dₘₐₓ | 1000 | mm |
| Vₗᵢₘᵢₜ | 3000 | mm/s |
| Aₗᵢₘᵢₜ | 30000 | mm/s² |
| T_{tact} | 1 | s |
| fₙ | 2 | Hz |

TABLE 2
Case 1 Result

| Input Condition | Value | |
|---|---|---|
| Phase | 1 | |
| Vₘₐₓ | 2000 | mm/s |
| Aₘₐₓ | 4000 | mm/s² |

| | |
|---|---|
| α | 0.5 |
| β | 0 |
| γ | 0 |

### Examples of Generating a Second Order Velocity Profile

When the contents of Table 3 below are input as design parameters, the main coefficients of the generated velocity profile are shown in Table 4.

TABLE 3
Case 2

| Input Condition | Value | |
|---|---|---|
| Dₘₐₓ | 1000 | mm |
| Vₗᵢₘᵢₜ | 3000 | mm/s |
| Aₗᵢₘᵢₜ | 30000 | mm/s² |
| T_{tact} | 1 | s |
| fₙ | 4 | Hz |

TABLE 4
Case 2 Result

| Input Condition | Value | |
|---|---|---|
| Phase | 2 | |
| Vmax | 2000 | mm/s |
| Amax | 4000 | mm/s2 |

| | |
|---|---|
| α | 0.5 |
| β | 1 |
| γ | 0 |

### Examples of Generating a Third Order Velocity Profile

When the contents of Table 5 below are input as design parameters, the main coefficients of the generated velocity profile are shown in Table 6.

TABLE 5
Case 3

| Input Condition | Value | |
|---|---|---|
| Dₘₐₓ | 1000 | mm |
| Vₗᵢₘᵢₜ | 3000 | mm/s |
| Aₗᵢₘᵢₜ | 30000 | mm/s² |
| T_{tact} | 1 | s |
| fₙ | 8 | Hz |

TABLE 6
Case 3 Result

| Input Condition | Value | |
|---|---|---|
| Phase | 3 | |
| Vₘₐₓ | 2000 | mm/s |
| Aₘₐₓ | 4000 | mm/s² |

| | |
|---|---|
| α | 0.5 |
| β | 1 |
| γ | 1 |

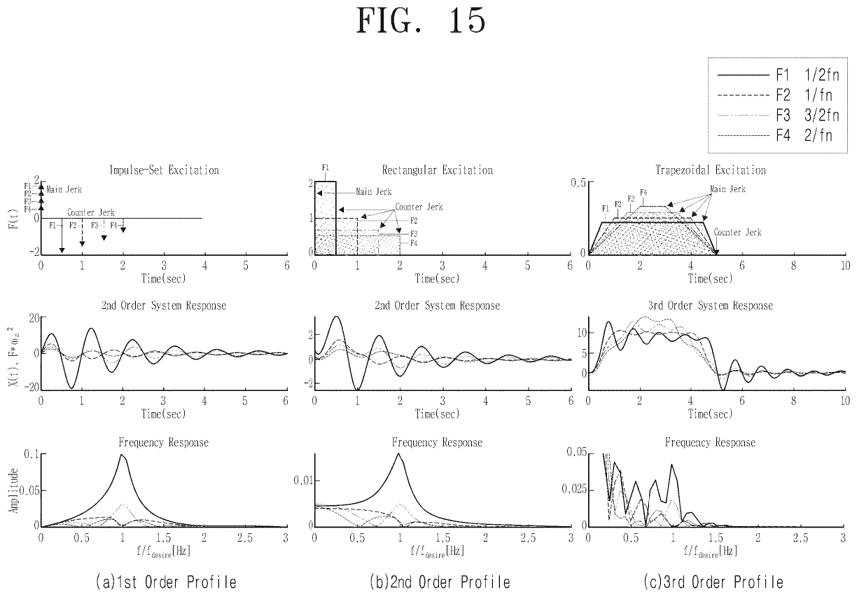

FIG. 15 is graphs illustrating charts related to a jerk in the first order, second order, and third order motion profiles.

In FIG. 15, only the jerk graph is taken from the three types of motion profile graphs described above. The top is the shape graph of the jerk (change of force applied to the system), the second graph is a vibration response when this force is applied to the secondary standard system (m-c-k), and the third graph is the vibration response graph subjected to a Fast Fourier Transform graph and then analyzed as a frequency response. Based on the same characteristic of each mechanical system (natural frequency), what characteristics the jerk shape has in the system were compared. For a system with a natural frequency of 1 Hz, the time point at which the counter jerk occurs means the time of 0.5 s, 1 s, 1.5 s, and 2 s.

Referring to FIG. 15, (a) illustrates a jerk shape of the first order motion profile. Here, the jerk acts as impact. The jerk means the change in acceleration. In other words, the differentiation of acceleration may be jerk. The system continues to receive acceleration until the sum of the jerk reaches zero for a certain period of time.

(b) illustrates the jerk shape of the second order motion profile. Here, the jerk acts in the form of a square area one order higher than the shape of the impact. The change in the jerk means the change in acceleration. In (b), the areas of the four cases are the same. That is, it is possible to see which the case where the high jerk acts for a short time or the case where the low jerk acts for a long time is advantageous for vibration reduction. This may be determined by the jerk ratio.

(c) illustrates the jerk shape of the third order motion profile. Here, the jerk acts in a trapezoidal form that is one order higher than the square area form. This shape has a jerk shape in the motion profile graph attached to the top. In the above manner, the areas are all the same, and the length of the X-axis is set to be the same. When the jerk ratio is fixed, the trapezoidal shape of the jerk is determined according to the snap ratio. It may be determined by the γ snap ratio.

It is acceleration that causes vibration in the robot system, but the vibration reacts more sensitively to changes in acceleration. Accordingly, the time point at which the jerk changes instead of a constant jerk is expressed as the main jerk and the counter jerk. As described above, the sum of the main jerk and the counter jerk needs to always be zero (otherwise, because the movement velocity of the hand 32 continues to increase or continues to decrease). Accordingly, the jerk applied in front is displayed as the main jerk, and the jerk applied in the back is displayed as the counter jerk. As a result of analyzing the frequency responses in each case, it was found that the system response was good in the form of a multiple of 1/fₙ (the residual vibration was small). In addition, it was confirmed that the larger the multiple value, the smaller the residual vibration.

In other words, according to the exemplary embodiment of the present invention, since the natural frequency fₙ generated by the operation of the robot system is derived and a motion profile MP is generated based on the derived natural frequency, residual vibration generated by the operation of the robot 30 may be minimized and quickly reduced. In addition, according to the exemplary embodiment of the present invention, since a motion profile MP that satisfies all preset design parameters is automatically generated, there is a technical advantage of shortening the time required to generate the motion profile MP. In addition, even if a user generates a motion profile MP, only the design parameters need to be input according to a set reference, so that it is possible to minimize the vibration reduction quality of the motion profile MP depending on the user's skill level.

In the above-described example, the present invention has been described based on the case where a vibration coefficient is designed while sequentially increasing i, j, and k as an example, but is not limited thereto. For example, the vibration coefficient may also be designed while sequentially decreasing i, j, and k.

The foregoing detailed description illustrates the present invention. Further, the above content shows and describes the exemplary embodiment of the present invention, and the present invention may be used in various other combinations, modifications, and environments. That is, the foregoing content may be modified or corrected within the scope of the concept of the invention disclosed in the present specification, the scope equivalent to that of the invention, and/or the scope of the skill or knowledge in the art. The foregoing exemplary embodiment describes the best state for implementing the technical spirit of the present invention, and various changes required in specific application fields and uses of the present invention are possible. Accordingly, the detailed description of the invention above is not intended to limit the invention to the disclosed exemplary embodiment. Further, the accompanying claims should be construed to include other exemplary embodiments as well.

What is claimed is:

1. A method of controlling a robot system, the method comprising:
a vibration information collection operation of observing vibration generated during an operation of a robot and collecting natural frequency of the vibration;
a motion profile design operation of designing a motion profile based on the natural frequency collected in the vibration information collection operation; and
a robot operating operation of operating the robot based on the motion profile designed in the motion profile design operation,
wherein the motion profile design operation includes designing a first order motion profile based on a primary vibration coefficient, which is a multiple of a reciprocal number of the natural frequency.

2. The method of claim 1, wherein the primary vibration coefficient is defined by Equation 1 below,
$$α = \frac{i}{{f}_{n}} , ( i = 1 , 2 , 3 , … ) \qquad ( Equation 1 )$$
α: the primary vibration coefficient
i: natural number of 1 or more
fₙ: the natural frequency
the motion profile design operation includes:
temporarily designing the primary vibration coefficient while sequentially increasing a value of i from 1; and
checking whether a length of a constant velocity section included in the first order motion profile based on the temporarily designed primary vibration coefficient is equal to or greater than 0.

3. The method of claim 2, comprising:
when the length of the constant velocity section is equal to or greater than 0, temporarily designing the primary vibration coefficient again by increasing the value of i; and
when the length of the constant velocity section is less than 0, determining a value obtained by reducing the value of i by 1 as a final value of i and deriving a final primary vibration coefficient based on the determined value of i.

4. The method of claim 3, comprising:
when the determined value of i is 1, determining the first order motion profile based on the final primary vibration coefficient as the motion profile operating the robot.

5. The method of claim 4, comprising:
when the determined value of i is not 1, designing a second order motion profile based on a secondary vibration coefficient,
wherein the secondary vibration coefficient is defined by Equation 2 below,
$$β = 2 \frac{1}{α} \frac{j}{{f}_{n}} , ( j = 1 , 2 , 3 , … ) \qquad ( Equation 2 )$$
β: the secondary vibration coefficient
α: the primary vibration coefficient
j: natural number of 1 or more
fₙ: the natural frequency.

6. The method of claim 5, wherein the motion profile design operation includes:
temporarily designing the secondary vibration coefficient while sequentially increasing a value of j from 1; and
determining whether the temporarily designed secondary vibration coefficient is greater than 0 and equal to or less than 1.

7. The method of claim 6, comprising:
when the temporarily designed secondary vibration coefficient satisfies a condition greater than 0 and equal to or less than 1, temporarily designing the secondary vibration coefficient again by increasing the value of j; and
when the temporarily designed secondary vibration coefficient does not satisfy the condition greater than 0 and equal to or less than 1, determining a value obtained by reducing the value of j by 1 as a final value of j, and deriving the final secondary vibration coefficient based on the determined final value of j.

8. The method of claim 7, comprising:
when the determined value of j is 1, determining the second order motion profile based on the final secondary vibration coefficient as the motion profile operating the robot.

9. The method of claim 8, comprising:
when the determined value of j is not 1, designing a third order motion profile based on a tertiary vibration coefficient,
wherein the tertiary vibration coefficient is defined by Equation 3 below,
$$γ = 4 \frac{1}{α β} \frac{k}{{f}_{n}} , ( k = 1 , 2 , 3 , … ) \qquad ( Equation 3 )$$
γ: the tertiary vibration coefficient
α: the primary vibration coefficient
β: the secondary vibration coefficient
k: natural number of 1 or more
fₙ: the natural frequency.

10. The method of claim 9, wherein the motion profile design operation includes:
temporarily designing the tertiary vibration coefficient while sequentially increasing the value of k from 1; and
determining whether the temporarily designed tertiary vibration coefficient is greater than 0 and equal to or less than 1.

11. The method of claim 10, comprising:
when the temporarily designed tertiary vibration coefficient satisfies a condition greater than 0 and equal to or less than 1, temporarily designing the tertiary vibration coefficient again by increasing the value of k.

12. The method of claim 11, comprising:
when the temporarily designed tertiary vibration coefficient does not satisfy the condition greater than 0 and equal to or less than 1, determining the value obtained by reducing the value of k by 1 as a final value of k, and deriving the final tertiary vibration coefficient based on the determined final value of k.

13. The method of claim 12, comprising:
determining the third order motion profile based on the final tertiary vibration coefficient as the motion profile operating the robot.

14. The method of claim 1, wherein the motion profile design operation includes designing the first order motion profile based on a design parameter which is a limit condition for designing the motion profile and a multiple of a natural vibration period, and
the design parameter includes:
an operating time an actuator of the robot is driven in the robot operating operation; and
a movement distance, which is a distance that an object moves by the driving of the actuator of the robot while the robot is operating, and
the motion profile is designed to satisfy the operating time of the actuator and the movement distance of the object.

15. The method of claim 14, wherein the design parameter further includes a limit velocity and a limit acceleration of the actuator, and
the motion profile is designed so that a maximum velocity and a maximum acceleration of the actuator do not exceed the limit velocity and the limit acceleration.

16. A method of designing a velocity motion profile for operating a robot applied to semiconductor manufacturing equipment, the method comprising:
deriving a natural frequency by observing vibration generated while the robot is operating, and determining an application time of a counter jerk while changing a time interval from a time point when a main jerk occurs to a time point when the counter jerk occurs by the velocity motion profile based on the derived natural frequency,
wherein a first order velocity motion profile is designed based on an application time point when the determined counter jerk is applied.

17. The method of claim 16, wherein the time point of the application of the counter jerk is determined while changing the time interval to a multiple of a natural vibration period, which is a reciprocal number of the natural frequency.

18. The method of claim 17, wherein the velocity motion profile is generated based on a design parameter, which is a preset limit condition, and
the design parameter includes an operating time of the robot, a movement distance of an object moved by the operation of the robot, a limit velocity of a motor of the robot, and a limit acceleration of the motor.

19. The method of claim 18, wherein at least one nth order velocity profile that satisfies the design parameter, which is a limit condition, is generated while increasing the order of the main jerk and the counter jerk generated from the first order velocity profile n times, and
any one of the first order velocity profile and the nth order velocity profile is determined as the velocity profile for operating the robot.

20. A program stored in a recording medium performing the method of designing the velocity profile of claim 16.
